(19) United States
(12) Patent Application Publication
(10) Pub. No.: US 2014/0190138 A1
(43) Pub. Date: Jul. 10, 2014

(54) FILTER ASSEMBLY

(71) Applicant: D.B. ENVIRONMENTAL PROTECTION EQUIPMENT INC., Alma (CA)

(72) Inventor: Simon PALOMINO, Alma (CA)

(21) Appl. No.: 14/149,328

(22) Filed: Jan. 7, 2014

Related U.S. Application Data
(60) Provisional application No. 61/749,582, filed on Jan. 7, 2013.

(51) Int. Cl. B01D 46/00; B01D 46/24

(52) U.S. Cl. CPC B01D 46/0005; B01D 46/2411
USPC 55/501

(57) ABSTRACT

A filter assembly is for dust removal in various commercial applications. The filter assembly includes a cylindrical cage assembly defining a circular opening at one extremity thereof, a filter media removably insertable within the cage assembly through the circular opening and a radial support element pressfittedly and removably received within the cage assembly providing radial support between the filter media and the cage assembly. The filter assembly has several recyclable components and is adaptable to different operational lengths and operating temperatures, while also offering a longer operational life.

This application claims benefit of Ser. No. 61/749,582, filed 7 Jan. 2013 in the United States and which application is incorporated herein by reference. To the extent appropriate, a claim of priority is made to each of the above disclosed applications.

### FIELD OF THE INVENTION

The present invention generally relates to filtration systems. The present invention more specifically relates to a filter assembly for dust removal.

### BACKGROUND OF THE INVENTION

Alters have several different applications in various industries. Filters often use a filter media which may be supported within a supporting structure.

Filters can be made from woven or non-woven material placed within wire cages.

The filter media may include a number of folds along its filtration surface which may vary from one application to another. The configuration of the filtration media may lead to non-uniform accumulations of materials in certain areas of the filter and therefore decrease its filtering capacity or its useful operational life.

Prior art filters that have a unique configuration length in the form of cartridges may also be difficult to adapt to other applications requiring different filter lengths.

Filter media may also include foam materials that are only resistant up to temperatures of about 86° C.

Most known filters are also made of a single unitary component that must be discarded after its use. Such a unitary component is difficult to recycle.

Consequently, there is still a need for a filter assembly for dust removal applications that may increase the operational life of the filter, increase the temperatures in which the filter assembly may be used, increase the different length and diameter configurations in which the filter assembly is used or increase the number of components that may be recycled.

### SUMMARY OF THE INVENTION

An object of the present invention is to propose a filter assembly that satisfies at least one of the above-mentioned needs.

According to the present invention, that object is accomplished with a filter assembly comprising:
a cylindrical cage assembly defining a circular opening at one extremity thereof;
a filter media element removably insertable within the cage assembly through the circular opening; and
a radial support element pressfittedly and removably received within the cage assembly providing radial support between the filter media element and the cage assembly.

A non-restrictive description of a preferred embodiment of the invention will now be given with reference to the appended drawings.

### BRIEF DESCRIPTION OF THE DRAWINGS

FIG. 1 is a perspective view of a cage assembly of a filter assembly according to a preferred embodiment of the present invention.

FIGS. 2A and 2B are top and side views respectively of a radial support element of a filter assembly according to a preferred embodiment of the present invention.

FIGS. 3A and 3B are top and side views respectively of another radial support element of a filter assembly according to another preferred embodiment of the present invention.

FIGS. 4A and 4B are top and side views respectively of another radial support element of a filter assembly according to another preferred embodiment of the present invention.

FIGS. 5A and 5B are side and front views respectively of a filter media element of a filter assembly according to another preferred embodiment of the present invention.

### PREFERRED EMBODIMENTS OF THE PRESENT INVENTION

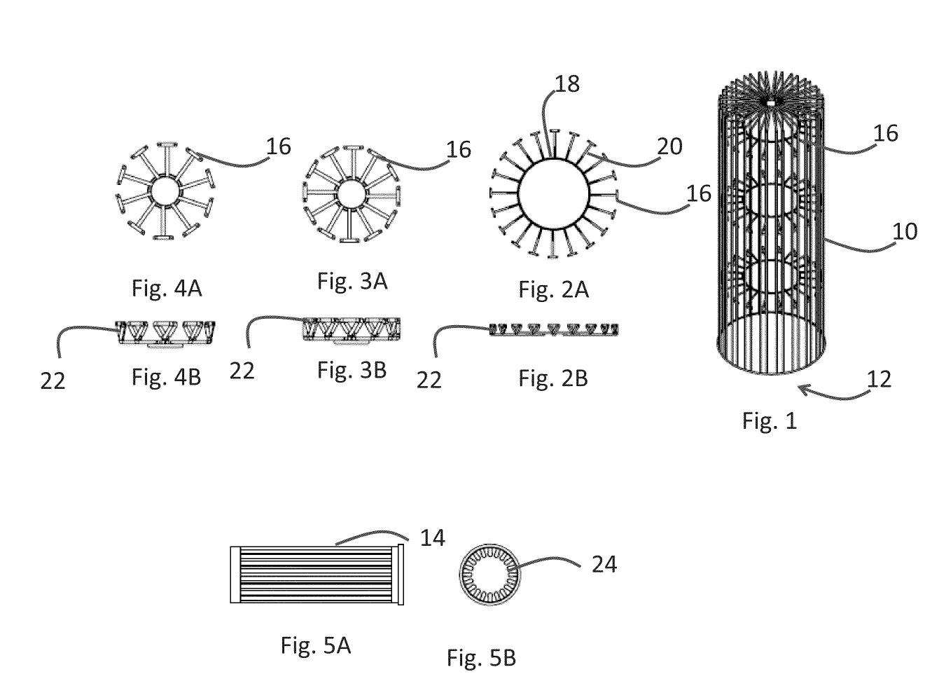

As shown in FIGS. 1 to 5B, different components of a filter assembly are disclosed. The filter assembly includes a cylindrical cage assembly 10 defining a circular opening 12 at one extremity thereof. The filter assembly also includes a filter media element 14 removably insertable within the cage assembly 10 through the circular opening 12. A radial support element 16 is pressfittedly and removably received within the cage assembly 10 providing radial support between the filter media element 14 and the cage assembly 10.

The filter assembly can be used in new or existing dust removal systems in various commercial applications including, but not limited to metallurgy, cement industries, aluminum industries, foundries, quarries, pharmaceutical industries, among others.

Due to its configuration, the filter assembly can be installed in various types of applications. Its versatility comes from the three main components described above.

The cage assembly and radial support element can be reused in other filter assemblies several times.

Preferably, the cage assembly includes a plurality of elongated wires linked to two opposite ring elements. This structural configuration of the elongated wires allows changes in the number of pleats of the filter media element, as well as in the number of spokes used in the radial support element. The number of elongated wires can range between 8 and 40.

Preferably, the plurality of elongated wires includes a plurality of equally spaced pairs of wires symmetrically positioned about the ring elements.

Preferably, the cage assembly may be made with a material selected from the group comprising black steel, aluminium, stainless steel or any other material that can resist to filter stresses.

Preferably, the radial support element 16 includes a central ring structure 18 and a plurality of spokes 20 extending substantially radially from the ring structure. The spokes 20 are sized to provide pressfit engagement between the radial support element 16 and the cage assembly 10.

Preferably, as better shown in FIG. 2B, 3B or 4B, each spoke 20 has a foot element 22 at an extremity thereof resting against at least one elongated wire of the cage assembly 10.

Preferably, the foot element 22 has a triangular wire shape sized to rest against a corresponding pair of the plurality of equally spaced pairs of wires.

Preferably, as better shown in FIGS. 5A and 5B, the filter media element 14 has a substantially hollow cylindrical structure comprising a wave-shaped inner surface 24. The inner wave-shape surface of the filter media helps avoid accumulation of material therein. Such a configuration can help avoid non-uniform accumulations of filtered materials in certain areas of the filter media and thus increase its filtering capacity or its useful operational life.

Preferably, the filter media element further comprises a sealing ring made of a material common to the filter media for sealing the filter assembly.

Preferably, the filter media element may be made of polyurethane, polypropylene, P-84, PTFE, fiberglass or other known filter media materials, without limitations as the filter media element is positioned within the cage assembly.

The material chosen for the filter media allows the filter assembly to be used at temperatures up to about 130° C. if glass fiber or polyester is used for example, or even up to 160° C. if a material such as P-84 is used for example.

The cage assembly structure for receiving the filter media allows the use of di filter media elements that may thus be used at higher temperatures.

The length of the overall filter assembly can reach important lengths 8 or 10 feet or more due to the configuration of the cage assembly and the use of the radial support elements. Diameters of the filters may be adjusted also for different applications with uses of different diameter radial support elements as shown in FIGS. 2A to 4B.

Although preferred embodiments of the present invention have been described in detail herein and illustrated in the accompanying drawings, it is to be understood that the invention is not limited to these precise embodiments and that various changes and modifications may be effected therein without departing from the scope of the present invention.

1. A filter assembly comprising:
a cylindrical cage assembly defining a circular opening at one extremity thereof;
a filter media element removably insertable within the cage assembly through the circular opening; and
at least one radial support element pressfittedly and removably received within the cage assembly providing radial support between the filter media element and the cage assembly.

2. The filter assembly according to claim 1, wherein the cage assembly comprises a plurality of elongated wires linked to two opposite ring elements.

3. The filter assembly according to claim 2, wherein the plurality of elongated wires comprises a plurality of equally spaced pairs of wires symmetrically positioned about the ring elements.

4. The filter assembly according to claim 3, wherein the radial support element comprises a central ring structure and a plurality of spokes extending substantially radially from the ring structure, the spokes sized to provide pressfit engagement between the radial support element and the cage assembly.

5. The filter assembly according to claim 4, wherein each spoke comprises a foot element at an extremity thereof resting against at least one elongated wire of the cage assembly.

6. The filter assembly according to claim 5, wherein the foot element has a triangular wire shape sized to rest against a corresponding pair of the plurality of equally spaced pairs of wires.

7. The filter assembly according to claim 1, wherein the filter media element has a substantially hollow cylindrical structure comprising a wave-shaped inner surface.

8. The filter assembly according to claim 2, wherein the filter media element has a substantially hollow cylindrical structure comprising a wave-shaped inner surface.

9. The filter assembly according to claim 3, wherein the filter media element has a substantially hollow cylindrical structure comprising a wave-shaped inner surface.

10. The filter assembly according to claim 4, wherein the filter media element has a substantially hollow cylindrical structure comprising a wave-shaped inner surface.

11. The filter assembly according to claim 5, wherein the filter media element has a substantially hollow cylindrical structure comprising a wave-shaped inner surface.

12. The filter assembly according to claim 6, wherein the filter media element has a substantially hollow cylindrical structure comprising a wave-shaped inner surface.

13. The filter assembly according to claim 7, wherein the filter media element further comprises a sealing ring made of a material common to the filter media for sealing the filter assembly.

14. The filter assembly according to claim 8, wherein the filter media element further comprises a sealing ring made of a material common to the filter media for sealing the filter assembly.

15. The filter assembly according to claim 9, wherein the filter media element further comprises a sealing ring made of a material common to the filter media for sealing the filter assembly.

16. The filter assembly according to claim 10, wherein the filter media element further comprises a sealing ring made of a material common to the filter media for sealing the filter assembly.

17. The filter assembly according to claim 11, wherein the filter media element further comprises a sealing ring made of a material common to the filter media for sealing the filter assembly.

18. The filter assembly according to claim 12, wherein the filter media element further comprises a sealing ring made of a material common to the filter media for sealing the filter assembly.
